(19) United States
(12) Patent Application Publication
(10) Pub. No.: US 2006/0212629 A1
(43) Pub. Date: Sep. 21, 2006

(54) Image forming system, image forming apparatus and terminal apparatus

(76) Inventors: Masahiro Suzuki, Tokyo (JP); Yoshiharu Tojo, Tokyo (JP); Yasuhiro Hattori, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/374,324

(22) Filed: Mar. 14, 2006

(30) Foreign Application Priority Data
Mar. 18, 2005 (JP) 2005-078929

(51) Int. Cl. G06F 13/00

(52) U.S. Cl. 710/104

(57) ABSTRACT

In an image forming system including an multifunctional machine, a PC and a server on a network, when a predetermined button is pushed on an operation unit of the multifunctional machine, the multifunctional machine sends a request for a plug-in list of a driver to the server so as to obtain the plug-in list and display it. When a user selects one in the plug-in list, the multifunctional machine requests a corresponding plug-in program from the server so as to obtain the plug-in program and install it into the own multifunctional machine. After that, the multifunctional machine reports to each PC used by users that a new function is plugged-in via a mail server. The PC obtains a driver from the multifunctional machine or the server, and installs it according to the report.

### BACKGROUND OF THF INVENTION

1. Field of the Invention

The present invention generally relates to an image forming system, an image forming apparatus and a terminal apparatus for updating a printer driver in the terminal apparatus. More particularly, the present invention relates to an image forming system that includes a multifunctional machine (that may be referred to as “MFP”) including an image forming apparatus, a server that is a management apparatus, a mail server and a terminal apparatus such as a PC as a client that are connected to a network, and relates to an image forming apparatus that forms the system, and the terminal apparatus.

2. Description of the Related Art

As a conventional technology relating to the method for updating the printer driver of the terminal apparatus such as a PC as a client that is connected to a network, a technology disclosed in Patent document 1 is known, for example. In this conventional technology, a client detects a printer on the network and obtains printer driver information stored in the printer so as to extract download information from the printer driver information. Then, based on the download information, the client downloads a printer driver from a printer driver server that is connected to the network and stores and manages printer drivers. After that, the client installs the downloaded printer driver into the client. According to the conventional technology, a printer driver can be installed without using a recording medium.

As another conventional technology, a technology disclosed in Patent document 2 is known. In this conventional technology, when a client moves on the network, the client finds a printer existing in a segment in which the moved client resides so as to install a printer driver of the printer. In addition, a port monitor is installed in the client to associate the printer with a printer port. Accordingly, a printer near a moving destination can be used.

[Patent document 1] Japanese Laid-Open Patent Application No. 2002-197044

[Patent document 2] Japanese Laid-Open Patent Application No. 2002-366502

In the aforementioned conventional technologies, a printer on a network to which the client is connected is detected so that a driver of the printer can be installed, and when a client moves to a network to which a printer is connected, the client can install a driver of the printer. However, the aforementioned conventional technologies do not consider updating a corresponding driver when a function of the multifunctional machine is updated.

### SUMMARY OF THF INVENTION

An object of the present invention is to provide an image forming system, an image forming apparatus, and a terminal apparatus in which an updated printer driver or a driver such as a scanner driver can be installed into the terminal apparatus such as a PC connected to the network.

The object is achieved by an image forming system including an image forming apparatus, a terminal apparatus and a management apparatus that are connected via a network, the image forming apparatus including:

a download unit configured to download a plug-in program or a driver from the management apparatus;

an install unit configured to install the plug-in program downloaded by the download unit; and

an information transfer unit configured to send, to the terminal apparatus, information on the plug-in program, installed by the install unit.

In the image forming system, a mail server may be further connected to the network, and the mail server may includes a report unit configured to receive information from the information transfer unit of the image forming apparatus and to report to the terminal apparatus that a new plug-in program is installed.

In addition, the image forming system, the image forming apparatus may further includes a driver transfer unit configured to transfer a driver to the terminal apparatus, wherein the terminal apparatus includes an install unit configured to install the driver transferred by the driver transfer unit.

In the image forming system, the image forming apparatus may further includes a download instruction unit configured to send an instruction to the terminal apparatus to cause the terminal apparatus to download the driver from the management apparatus, and the terminal apparatus may include: a download unit configured to download the driver from the management apparatus in response to the instruction by the download instruction unit; and an install unit configured to install the driver downloaded by the download unit.

In addition, the image forming apparatus may further include a determination unit configured to determine a state of the terminal apparatus, wherein, according to a result of determination by the determination unit, the image forming apparatus determines whether to transfer the driver to the terminal apparatus or to report to the terminal apparatus that a new plug-in program is installed.

The object is also achieved by an image forming apparatus connected to a terminal apparatus and a management apparatus via a network, the image forming apparatus including:

a download unit configured to download a plug-in program or a driver from the management apparatus;

an install unit configured to install the plug-in program downloaded by the download unit; and

an information transfer unit configured to send, to the terminal apparatus, information on the plug-in program installed by the install unit.

The object is also achieved by a terminal apparatus connected to an image forming apparatus and a management apparatus, the terminal apparatus including:

a unit configured to receive report information, from the image forming apparatus, on a plug-in program, installed in the image forming apparatus.

The present invention can be also configured as method for updating a driver of a terminal apparatus in an image forming system including an image forming apparatus, the terminal apparatus and a management apparatus that are connected via a network, wherein: the image forming apparatus downloads a plug-in program or a driver from the management apparatus, installs the downloaded plug-in program, and sends, to the terminal apparatus, information on the plug-in program that is installed.

The present invention can be also configured as a method for updating a driver of a terminal apparatus connected to an image forming apparatus and a management apparatus via a network, wherein the terminal apparatus obtains a plug-in list of a driver in the image forming apparatus, downloads a plug-in program or a driver selected by a user from the obtained plug-in list, and installs the plug-in program or the driver.

According to the present invention, a user using the terminal apparatus can know that the printer driver or a driver such as the scanner driver is updated in the image forming apparatus. In addition, a driver in the terminal apparatus can be automatically updated from the image forming apparatus.

In addition, according to the present invention, the terminal apparatus used by a user can access the management apparatus to obtain a driver from the management apparatus so as to be able to update the driver in the own terminal apparatus based on an instruction for updating the driver from the image forming apparatus.

In addition, according to the present invention, even when a driver cannot be automatically updated for a terminal apparatus due to power disconnection and the like, a guidance mail indicating that a new function plug-in is installed in the image forming apparatus can be transferred so that the information can be reported to the user.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a network configuration of an image forming system in an embodiment of the present invention;

FIG. 2 is a block diagram showing configurations of apparatuses connected to a network of the image forming system;

FIG. 3 is a sequence chart for explaining a first example of operation in an embodiment of the present invention;

FIG. 4 shows an example of mail addresses registered in the multifunctional machine;

FIG. 5 is a sequence chart for explaining a second example of operation in an embodiment of the present invention;

FIG. 6 shows an example of an IP address list registered in the multifunctional machine;

FIG. 7 is a sequence chart for explaining a third example of operation in an embodiment of the present invention;

FIG. 8 is a flowchart for explaining a fourth example of operation in an embodiment of the present invention.

### DETAILED DESCRIPTION OF THE PREFERRED EMBODIMENTS

In the following, embodiments of the image forming system, the image forming apparatus, the terminal apparatus, the management apparatus and the method for updating the printer driver of the terminal apparatus are described in detail with reference to figures.

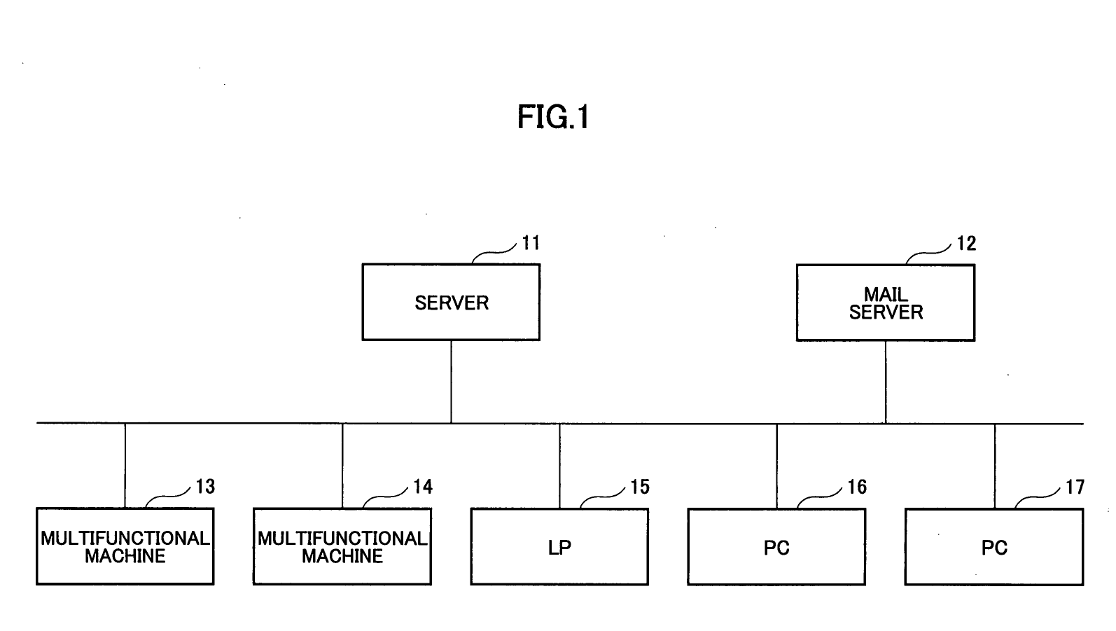

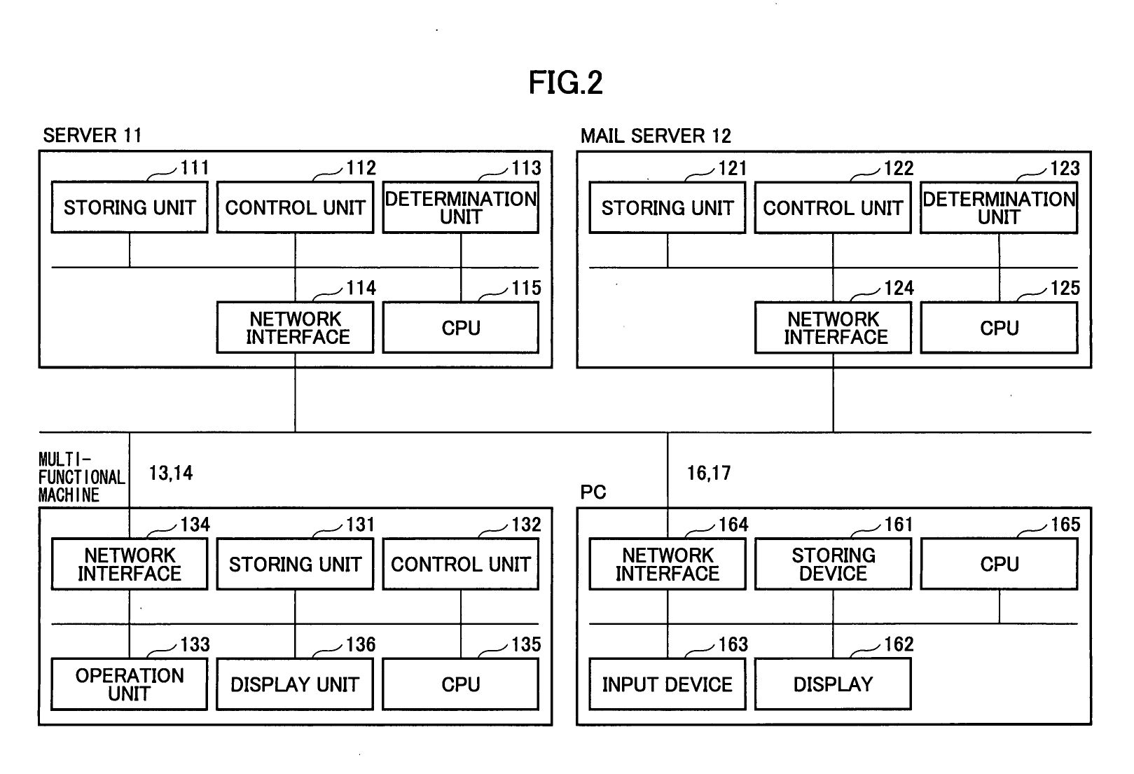

FIG. 1 is a block diagram showing a network configuration of the image forming system in an embodiment of the present invention. FIG. 2 is a block diagram showing configurations of apparatuses connected to the network of the image forming system. In FIGS. 1 and 2, the reference number 11 indicates a server, 12 indicates a mail server, 13 and 14 indicate multifunctional machines, 15 indicates a laser printer, 16 and 17 indicate PCs, 111, 121 and 131 indicate storing units, 112, 122 and 132 indicate control units, 113 and 123 indicate determination units, 114, 124, 134 and 164 indicate network interfaces, 115, 125, 135 and 165 indicate CPUs, 162 indicates a display, and 163 indicates an input device.

The image forming system of the embodiment of the present invention includes a download server (to be simply referred to as a server hereinafter) 11, a mail server 12, a plurality of multifunctional machines 13 and 14, the laser printer 13, and PCs that are connected to the network. The server 11 and the mail server 12 may be configured as one server.

The server 11 is a management apparatus for storing and managing plug-in programs, printer drivers and a list of the plug-in programs (to be simply referred to as a plug-in list hereinafter). The mail server 12 relays mails and manages transmit and receive of mails among apparatuses. Each of the multifunctional machines 13 and 14 performs plural functions such as a scanner function and the like. The laser printer 15 performs only printing. The PC is a terminal apparatus that is an information processing apparatus used by a user.

In the image forming apparatus configured as mentioned before, each of the PCs 16 and 17 includes a printer driver. Therefore, by selecting one of the multifunctional machines 13, 14 and the laser printer 15 and by sending an instruction, the PC can cause the selected machine to print a necessary document.

In the image forming system shown in FIG. 1, the server 11 includes the storing unit 111, the control unit 112, the determination unit 113, the network I/F 114 and the CPU 115. The server 11 receives an instruction or a request from another apparatus via the network I/F 114. The determination unit 113 determines the instruction or the request so that the server 11 sends a plug-in list, a printer driver, a plug-in program or the like to a source of the request. Like the server 11, the mail server 12 includes the storing unit 121, the control unit 122, the determination unit 123, the network I/F 124 and the CPU 125.

Each of the multifunctional machines includes multiple functions such as the image forming apparatus function, the scanner function and the like, and further includes an information processing function. As shown in FIG. 2, the multifunctional machine includes the storing unit 131, the control unit 132, the operation unit 133, the network I/F 134, the CPU 115 and the display unit 136. The multifunctional machine can copy operation based on an instruction from a user input using the operation unit 133, or can print a document and the like based on an instruction from a PC 16 or 17 input via the network I/F 134.

Each of the PCs 16 and 17 is a terminal apparatus for information processing used by an individual user, and includes a storing unit 161, a display 162, an input device 163, a network I/F 164 and a CPU 165 as shown in FIG. 2.

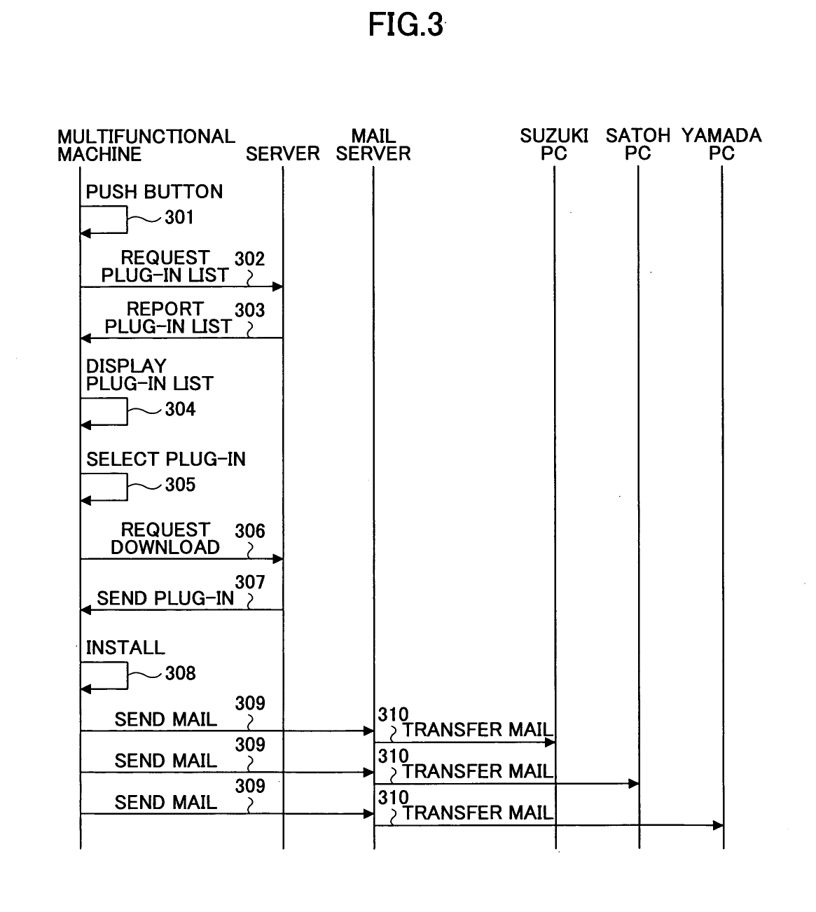

FIG. 3 is a sequence chart for explaining a first example of operation in this embodiment. The operation is described with reference to FIG. 3 in the following.

(1) The user pushes a predetermined button on the operation unit 133 of the multifunctional machine 13 for displaying the plug-in list to check it (sequence 301).

(2) The multifunctional machine 13 sends a request for the plug-in list to the server 11 when detecting the push of the button (sequence 302).

(3) When the server 11 receives the request of the plug-in list, the server 11 sends the plug-in list stored in the storing unit 111 in the sever 11 to the multifunctional machine 13 (sequence 303).

(4) The multifunctional machine 13 receives the plug-in list sent from the server 11, and displays it on the display unit 136 (sequence 304).

(5) The user selects a plug-in that the user desires to install from the plug-in list displayed on the display unit 136 using a button of the operation unit 133 (sequence 305).

(6) The multifunctional machine 13 sends a request for downloading the plug-in selected by the user to the server 11 (sequence 306).

(7) When the server 11 receives the request for downloading the plug-in from the multifunctional machine 13, the server 11 sends the plug-in stored in the storing unit 111 to the multifunctional machine 13 (sequence 307).

(8) The multifunctional machine 13 stores the received plug-in into the storing unit 131 so as to install the plug-in (sequence 308).

(9) After that, the multifunctional machine 13 reports that a new function has been plugged-in to mail addresses registered in the multifunctional machine 13 using an e-mail function. The destinations for the report are PCs 16 and 17 used by the users connected to the network. In the example shown in FIG. 3, the PCs are used by “Suzuki”, “Satoh” and “Yamada”. The mails from the multifunctional machine 13 are transferred by the mail server 12 so as to be distributed to each PC (sequences 309, 310).

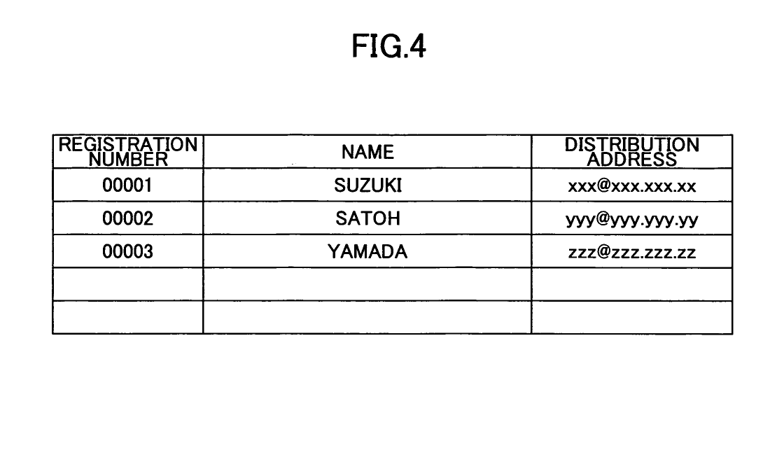

FIG. 4 shows an example of mail addresses registered in the multifunctional machine 13. As shown in this example, each mail address is registered as a record including a registered number, a name and a distribution address. As the address, a mail address registered in the multifunctional machine for scanner distribution can be used.

According to the aforementioned processing, the user using the PC can know that updating of functions (adding and updating of the plug-in program, for example) is performed in the multifunctional machine.

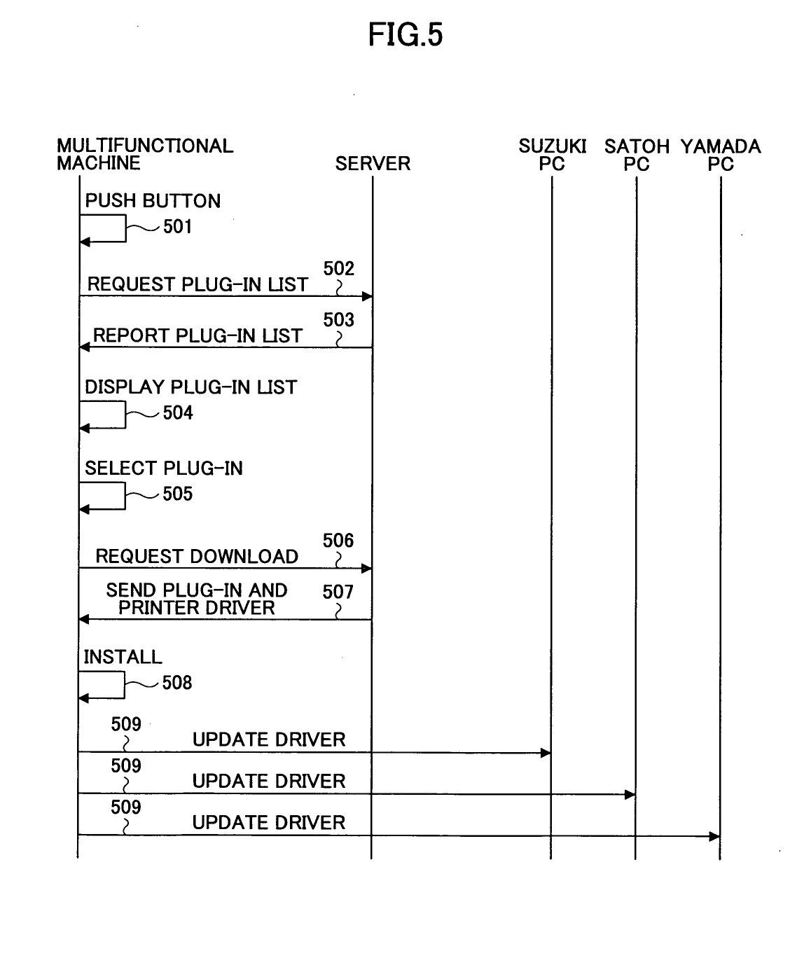

FIG. 5 is a sequence chart for explaining a second example of operation in the embodiment of the present embodiment. The operation is described with reference to FIG. 5 in the following.

(1) The user pushes a predetermined button on the operation unit 133 of the multifunctional machine 13 for displaying the plug-in list to check it (sequence 501).

(2) The multifunctional machine 13 sends a request for the plug-in list to the server 11 when detecting the push of the button (sequence 502).

(3) When the server 11 receives the request of the plug-in list, the server 11 sends the plug-in list stored in the storing unit 111 in the sever 11 to the multifunctional machine 13 (sequence 503).

(4) The multifunctional machine 13 receives the plug-in list sent from the server 11, and displays it on the display unit 136 (sequence 504).

(5) The user selects a plug-in that the user desires to install from the plug-in list displayed on the display unit 136 using a button of the operation unit 133 (sequence 505).

(6) The multifunctional machine 13 sends a request for downloading the plug-in selected by the user to the server 11 (sequence 506).

The operation so far is the same as the sequences 301-306 described in FIG. 3.

(7) When the server 11 receives the request for downloading the plug-in from the multifunctional machine 13, the server 11 sends the plug-in program stored in the storing unit 111 and a printer driver corresponding to the plug-in program to the multifunctional machine 13 (sequence 507).

(8) The multifunctional machine 13 stores the received plug-in program into the storing unit 131 so as to install the plug-in (sequence 508).

(9) After that, the multifunctional machine 13 updates a printer driver in each PC into the printer driver obtained from the server 11 according to the IP address list registered in the multifunctional machine 13. The PCs for which updating of the printer driver is to be performed are PCs 16 and 17 used by the users connected to the network. In the example shown in FIG. 5, the PCs are used by “Suzuki”, “Satoh” and “Yamada” (sequence 509).

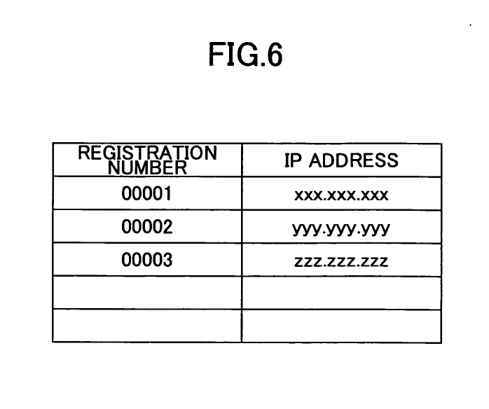

FIG. 6 shows an example of an IP address list registered in the multifunctional machine 13. The IP address list is a list of IP addresses of a plurality of PCs connected via the network. As shown in this example, each IP address is registered as a record including a pair of registered number and an IP address.

According to the aforementioned processing, the printer driver in the PC used by an individual user can be automatically updated from the multifunctional machine.

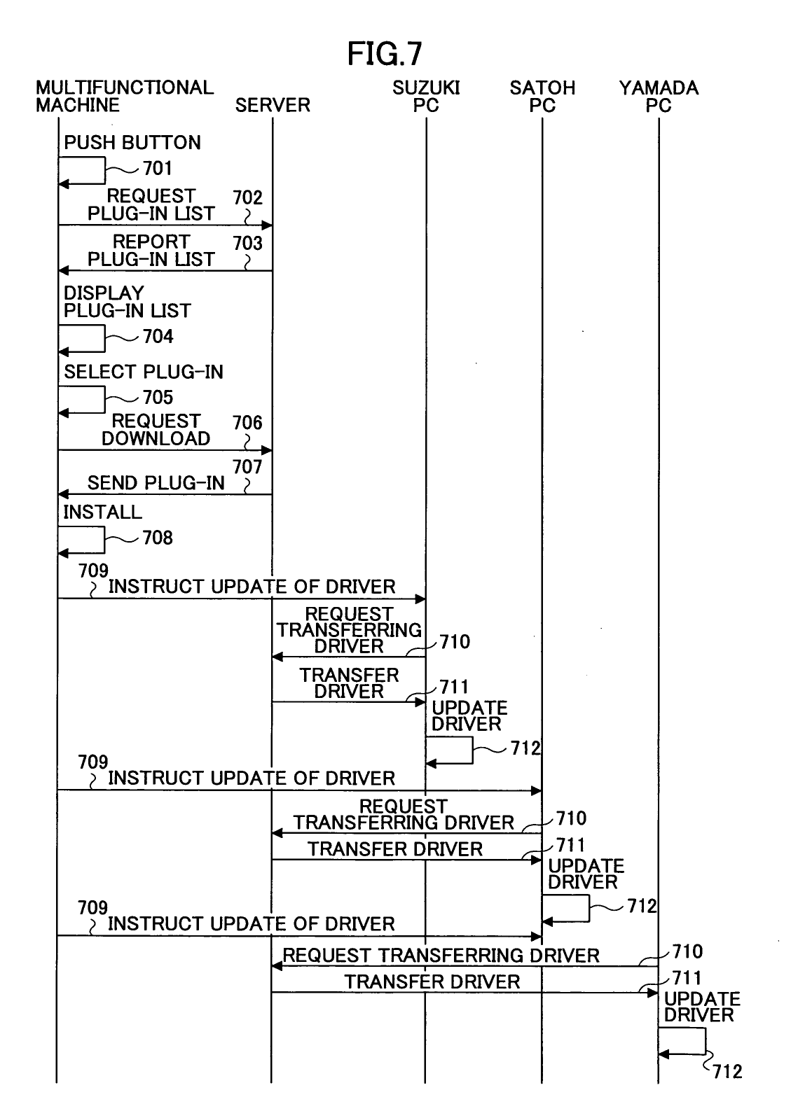

FIG. 7 is a sequence chart for explaining a third example of operation in the embodiment of the present invention. The operation is described with reference to FIG. 7 in the following.

(1) The user pushes a predetermined button on the operation unit 133 of the multifunctional machine 13 for displaying the plug-in list to check it (sequence 701).

(2) The multifunctional machine 13 sends a request for the plug-in list to the server 11 when detecting the push of the button (sequence 702).

(3) When the server 11 receives the request for the plug-in list, the server 11 sends the plug-in list stored in the storing unit 111 in the sever 11 to the multifunctional machine 13 (sequence 703).

(4) The multifunctional machine 13 receives the plug-in list sent from the server 11, and displays it on the display unit 136 (sequence 704).

(5) The user selects a plug-in that the user desires to install from the plug-in list displayed on the display unit 136 using a button of the operation unit 133 (sequence 705).

(6) The multifunctional machine 13 sends a request for downloading the plug-in selected by the user to the server 11 (sequence 706).

(7) When the server 11 receives the request for downloading the plug-in from the multifunctional machine 13, the server 11 sends the plug-in program stored in the storing unit 111 and a printer driver corresponding to the plug-in program to the multifunctional machine 13 (sequence 707).

(8) The multifunctional machine 13 stores the received plug-in program into the storing unit 131 so as to install the plug-in (sequence 708).

The operation so far is the same as the sequences 501-508 described in FIG. 5.

(9) After that, the multifunctional machine 13 sends an instruction for updating a printer driver to each PC according to the IP address list registered in the multifunctional machine 13. The PCs to which the instruction is to be sent are PCs 16 and 17 used by the users connected to the network. In the example shown in FIG. 5, the PCs are used by “Suzuki”, “Satoh” and “Yamada” (sequence 709).

(10) Each PC that receives the instruction for updating the printer driver sends, to the server 11, a request for transferring a printer driver (step 710).

(11) The server 11 that receives the request for transferring the printer driver from each PC sends the printer driver to each PC that sends the request (step 711).

(12) Each PC receives the printer driver sent from the server 11, and automatically updates a printer driver in the PC with the printer driver received from the server (step 712).

According to the aforementioned processing, based on the instruction for updating the printer driver received from the multifunctional machine 13, the PC used by each user can access the server so as to obtain the printer driver from the server 11 and update the printer driver in the PC with the obtained printer driver.

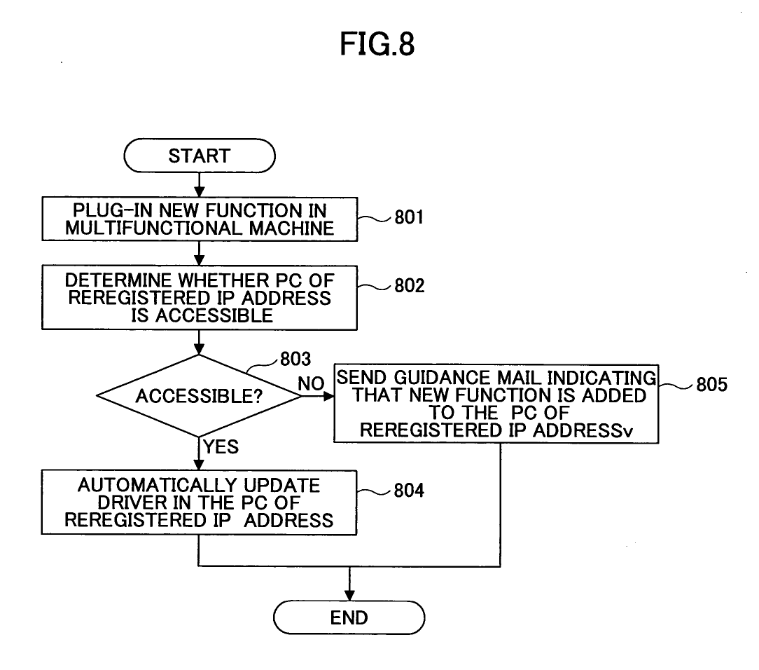

FIG. 8 is a flowchart for explaining a fourth example of operation in the embodiment of the present invention. The operation is described with reference to FIG. 8 in the following.

(1) The multifunctional machine 13 installs the plug-in program received from the server 11 in step 801. This processing is performed in the same way as the sequences 301-308 in FIG. 3, sequences 501-508 in FIG. 5, or sequences 701-708 in FIG. 7.

(2) Next, the multifunctional machine 13 determines whether the multifunctional machine 13 can access each PC corresponding to the IP addresses registered in the multifunctional machine 13. For example, the multifunctional machine 13 determines whether each PC is powered on and connected to the network. The multifunctional machine 13 has configuration information of the network and manages change of the network configuration, that is, change of apparatuses connected to the network, so that the multifunctional machine 13 can perform the determination easily (step 802).

(3) According to the determination in step 802, when each PC is accessible, the multifunctional machine 13 automatically updates the printer driver in each PC corresponding to the registered IP addresses. The automatic update of the printer driver can be performed in the same way as the sequences described in FIG. 5 and FIG. 7 (steps 803, 804).

(4) When there is a PC that is not accessible, the multifunctional machine 13 sends a guidance mail indicating that a plug-in program having a new function is installed in the multifunctional machine 13 to the PC using a corresponding IP address. The guidance mail can be transferred in the same way as the sequence shown in FIG. 3 (step 805).

According to the aforementioned processing, even when a PC cannot perform automatic update of the printer driver due to power disconnection and the like, the multifunctional machine 13 can send the guidance mail indicating that the plug-in program having the new function is installed in the multifunctional machine 13 to the PC so that the user of the PC can know that.

The processing in each embodiment in the sequences and the flows can be realized using a program. The program can be executed by the CPU in the multifunctional machine, PC or server. In addition, the program can be provided by storing it into a FD, a CDROM, a DVD or the like.

In embodiments described so far, the printer driver is updated in the terminal apparatus such as the PC or an update information is reported. However, the present invention is not limited to updating the printer driver. For example, the present invention can be applied to updating other driver such as a scanner driver of a scanner included in the multifunctional machine. In addition, in embodiments described so far, a method for updating the plug-in is described. However, the present invention can be similarly applied to a case when a whole program is updated.

The present invention is not limited to the specifically disclosed embodiments, and variations and modifications may be made without departing from the scope of the present invention.

The present application contains subject matter related to Japanese patent application No. 2005-078929, filed in the JPO on Mar. 18, 2005, the entire contents of which are incorporated herein by reference.

What is claimed is:

1. An image forming system including an image forming apparatus, a terminal apparatus and a management apparatus that are connected via a network, the image forming apparatus comprising:
a download unit configured to download a plug-in program or a driver from the management apparatus;
an install unit configured to install the plug-in program downloaded by the download unit; and
an information transfer unit configured to send, to the terminal apparatus, information on the plug-in program installed by the install unit.

2. The image forming system as claimed in claim 1, wherein a mail server is further connected to the network, and the mail server comprises a report unit configured to receive information from the information transfer unit of the image forming apparatus and to report to the terminal apparatus that a new plug-in program is installed.

3. The image forming system as claimed in claim 1, the image forming apparatus further comprising a driver transfer unit configured to transfer a driver to the terminal apparatus,
wherein the terminal apparatus includes an install unit configured to install the driver transferred by the driver transfer unit.

4. The image forming system as claimed in claim 1, the image forming apparatus further comprising a download instruction unit configured to send an instruction to the terminal apparatus to cause the terminal apparatus to download the driver from the management apparatus, and
the terminal apparatus comprising:
a download unit configured to download the driver from the management apparatus in response to the instruction by the download instruction unit; and
an install unit configured to install the driver downloaded by the download unit.

5. The image forming system as claimed in claim 3, the image forming apparatus further comprising a determination unit configured to determine a state of the terminal apparatus,
wherein, according to a result of determination by the determination unit, the image forming apparatus determines whether to transfer the driver to the terminal apparatus or to report to the terminal apparatus that a new plug-in program is installed.

6. An image forming apparatus connected to a terminal apparatus and a management apparatus via a network, the image forming apparatus comprising:
a download unit configured to download a plug-in program or a driver from the management apparatus;
an install unit configured to install the plug-in program downloaded by the download unit; and
an information transfer unit configured to send, to the terminal apparatus, information on the plug-in program installed by the install unit.

7. The image forming apparatus as claimed in claim 6, the image forming apparatus further comprising a driver transfer unit configured to transfer a driver to the terminal apparatus.

8. The image forming apparatus as claimed in claim 6, the image forming apparatus further comprising a download instruction unit configured to send an instruction to the terminal apparatus to cause the terminal apparatus to download the driver from the management apparatus.

9. The image forming apparatus as claimed in claim 7, the image forming apparatus further comprising a determination unit configured to determine a state of the terminal apparatus,
wherein, according to a result of determination by the determination unit, the image forming apparatus determines whether to transfer the driver to the terminal apparatus or to report to the terminal apparatus that a new plug-in program is installed.

10. A terminal apparatus connected to an image forming apparatus and a management apparatus via a network, the terminal apparatus comprising:
a unit configured to receive report information, from the image forming apparatus, on a plug-in program installed in the image forming apparatus.

11. The terminal apparatus as claimed in claim 10, the terminal apparatus further comprising:
a unit configured to receive a driver transferred from the image forming apparatus; and
an install unit configured to install the transferred driver.

12. The terminal apparatus as claimed in claim 10, the terminal apparatus further comprising:
a unit configured to receive an instruction to download a driver from the management apparatus;
a download unit configured to download the driver from the management apparatus in response to the received instruction; and
an install unit configured to install the driver downloaded by the download unit.
